(19) United States
(12) Patent Application Publication
(10) Pub. No.: US 2014/0343748 A1
(43) Pub. Date: Nov. 20, 2014

(54) COOLING METHOD FOR COOLING ELECTRONIC DEVICE, INFORMATION PROCESSING APPARATUS AND STORAGE MEDIUM

(71) Applicant: FUJITSU LIMITED, Kawasaki-shi (JP)

(72) Inventor: Takeshi Suzuki, Kawasaki (JP)

(21) Appl. No.: 14/452,109

(22) Filed: Aug. 5, 2014

Related U.S. Application Data
(63) Continuation of application No. PCT/JP2012/001126, filed on Feb. 20, 2012.

(51) Int. Cl. G05B 15/02; F28F 27/00

(52) U.S. Cl. CPC G05B 15/02; F28F 27/00
USPC 700/300

(57) ABSTRACT

A cooling method for cooling an electronic device that is performed by a processor included in an information processing apparatus, the cooling method includes acquiring a temperature history of the electronic device during a guaranteed period of the electronic device; determining a remaining lifetime of the electronic device by using a prediction model based on the temperature history; determining a reference temperature corresponding to the remaining lifetime and a remainder of the guaranteed period, the remainder indicating a difference of the guaranteed period and a total operation time of the electric device; setting a target temperature to cool the electronic device based on a comparison between the reference temperature and a predetermined temperature indicating an upper limit of the target temperature.

### CROSS-REFERENCE TO RELATED APPLICATION

This application is a continuation application of International Application PCT/JP2012/001126 filed on Feb. 20, 2012, the entire contents of which are incorporated herein by reference.

### FIELD

The embodiment discussed herein is related to a cooling method for an electronic device, to an information processing apparatus and to a storage medium.

### BACKGROUND

Electronic devices such as central processing units (CPUs) and hard disk drives (HDDs) are incorporated into information processing apparatuses such as server apparatuses. Deterioration of such electronic devices progresses and operation of such electronic devices as components becomes more unstable with the passage of usage time. Therefore, a guaranteed operation period of an information processing apparatus is set based on the lifetimes of the components used in the information processing apparatus.

It is known that degradation over time of such electronic devices depends on the use environment temperature of the information processing apparatus and that the higher the use environment temperature becomes, the more likely it is for the degradation over time to be accelerated. Therefore, it is desirable to sufficiently cool the information processing apparatus so that the guaranteed operation period may be guaranteed with certainty. However, in recent years, with the increasing performance of CPUs used in information processing apparatuses, the amount of heat generated has been increasing and the amount of power consumed to perform cooling has also been increasing. A CPU is cooled using a cooling fan for example. The rotational speed of the cooling fan may be controlled so that a heat source that is a target of cooling is at a certain use environment temperature. As examples of the related art, for example, Japanese Laid-open Patent Publication No. 2007-295703, Japanese Patent No. 4075455 (corresponding to Japanese Laid-open Patent Publication No. 2002-349939), and Japanese Patent No. 3387395 (corresponding to Japanese Laid-open Patent Publication No. 11-142028) have been disclosed.

The lifetime of the information processing apparatus is calculated assuming that the information processing apparatus will be continuously used at a certain use environment temperature and the guaranteed operation period is set based on the calculated lifetime. For example, if the upper limit temperature for the use environment temperature is 35° C., the rotational speed of the cooling fan is set such that it is possible to maintain the use environment temperature at 35° C. By performing cooling at the set rotational speed, the guaranteed operation period of the information processing apparatus may be fulfilled.

However, if the actual use environment temperature does not reach 35° C., that is, if the temperature is lower than 35° C., progression of degradation over time of the information processing apparatus is restrained and therefore the actual lifetime becomes longer than the assumed lifetime and a lifetime margin is generated. However, despite the generation of a lifetime margin, since the rotational speed of the cooling fan has been set under the assumption that the use environment temperature will be 35° C., more power is consumed than has to be due to cooling being excessively performed.

### SUMMARY

According to an aspect of the embodiments, a cooling method for cooling an electronic device that is performed by a processor included in an information processing apparatus, the cooling method includes acquiring a temperature history of the electronic device during a guaranteed period of the electronic device; calculating a remaining lifetime of the electronic device by using a prediction model based on the temperature history; determining a reference temperature corresponding to the remaining lifetime and a remainder of the guaranteed period, the remainder indicating a difference of the guaranteed period and a total operation time of the electric device; setting a target temperature to cool the electronic device based on a comparison between the reference temperature and a predetermined temperature indicating an upper limit of the target temperature.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of an information processing apparatus of an embodiment;

FIG. 2 illustrates an example of a relationship between a use environment temperature of a device that is a target of cooling and a rotational speed of a cooling fan;

FIG. 3 illustrates an Arrhenius model based on an Arrhenius model equation;

FIG. 4 is a sequence diagram illustrating processing of storing various pieces of information used in deciding upon a cooling setting temperature in the embodiment;

FIG. 5 is a sequence diagram illustrating processing from after storing of various pieces of information used in deciding upon a cooling setting temperature up to the start of processing for deciding upon the cooling setting temperature in the embodiment;

FIG. 6 is a sequence diagram illustrating processing of deciding upon a cooling setting temperature in the embodiment;

FIG. 7 is a diagram for explaining a relationship between time that has elapsed since an operation start date and consumed lifetime in the embodiment;

FIG. 8 is a diagram for explaining the effect of a reduction in power consumption realized by updating the cooling setting temperature; and

FIG. 9 illustrates an example of a database in which the use environment temperature and an acceleration factor are associated with each other.

### DESCRIPTION OF EMBODIMENT

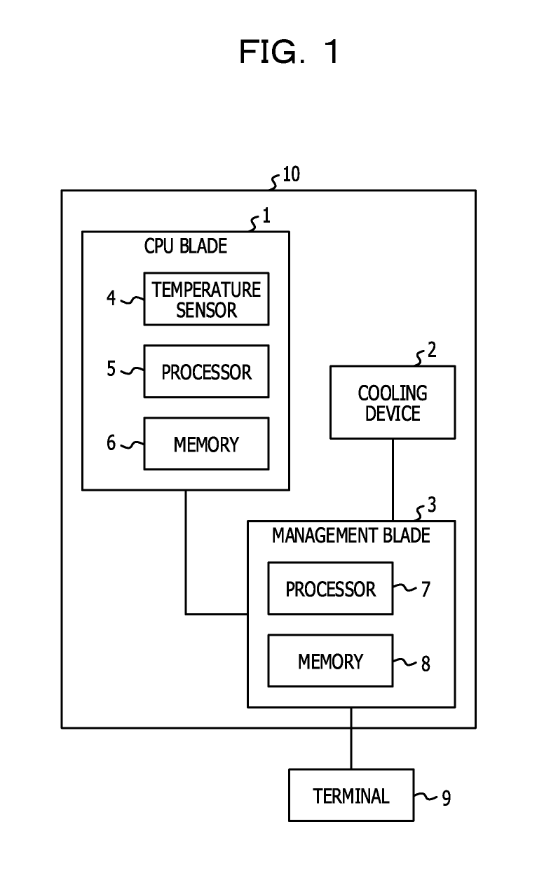

Hereafter, a specific embodiment will be described while referring to FIGS. 1 to 11.

FIG. 1 illustrates an example of an information processing apparatus of an embodiment. As illustrated in FIG. 1, an information processing apparatus 10 includes a CPU blade 1, a cooling device 2 that cools the CPU blade 1, and a management blade 3 that controls the cooling device 2. The CPU blade 1 and the management blade 3 form an example of a blade server and are equipped with a motherboard, which is not illustrated, on which components (electronic devices) that make up the server are mounted. The CPU blade 1 and the management blade 3 are removably contained in a rack inside a casing (rack), which is not illustrated, of the information processing apparatus 10 and form an entire server system by being connected to each other so as to be capable of communicating with each other.

Hereafter, each component of the information processing apparatus will be described in detail.

The CPU blade 1 includes a temperature sensor 4, a processor 5 and a memory 6. The CPU blade 1 is an example of a device that is a target of cooling in the embodiment. The temperature sensor 4 is mounted in the vicinity of an intake port (not illustrated) of the CPU blade 1 and is capable of measuring a use environment temperature of the CPU blade 1. The processor 5 instructs the temperature sensor 4 to measure the use environment temperature of the CPU blade 1 and performs control to store the obtained information on the use environment temperature in the memory 6. The processor 5 is a CPU for example.

The information on the use environment temperature obtained by the temperature sensor 4 is stored as a temperature history in the memory 6. Information on an upper limit temperature for the use environment temperature of the CPU blade 1 is stored in the memory 6. The information on the upper limit temperature is for example stored in firmware installed in the memory 6. As the memory 6, for example, a semiconductor memory such as a read only memory (ROM) or a random access memory (RAM), or a HDD may be used. The memory 6 is not limited to being a single memory and a plurality of memories 6 may be provided in accordance with the intended application and so forth.

The cooling device 2 is for example a cooling fan. It is often the case that heat generated in the CPU blade 1 is mainly caused by heat being generated by electronic devices such as the CPU mounted in the CPU blade 1. Consequently, it is preferable that the cooling device 2 be arranged near to the electronic devices so as to be capable of cooling the electronic devices. The cooling device 2 is connected to the management blade 3 so as to be capable of communicating with the management blade 3, which controls the cooling device 2. The cooling device 2 for example may be provided inside the CPU blade 1. Alternatively, the cooling device 2 may be arranged on a heat sink provided above the electronic device mounted on a board and be configured such that the heat sink and a fan motor thereof are integrated with each other.

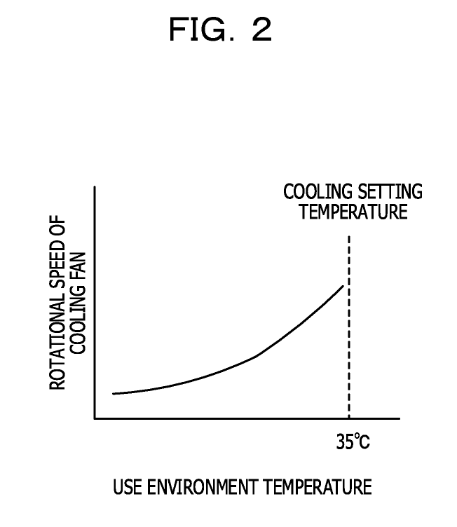

FIG. 2 illustrates an example of a relationship between a use environment temperature of a device that is a target of cooling and a rotational speed of a cooling fan. In the example illustrated in FIG. 2, a cooling setting temperature, which is a target temperature when cooling is performed, is 35° C. As illustrated in FIG. 2, the rotational speed of the cooling fan is dependent on the use environment temperature of the device that is the target of cooling. The cooling fan has a function of controlling its rotational speed so that the rotational speed automatically increases if the use environment temperature increases. Thus, it is possible to avoid a situation in which the use environment temperature exceeds the cooling setting temperature.

The management blade 3 is a blade server that has a function of controlling a cooling operation performed by the cooling device 2 and includes a processor 7 and a memory 8. The processor 7 is a CPU for example. The processor 7 has a function of, at a predetermined timing, deciding upon and updating a cooling setting temperature that is set in order to cool the CPU blade 1. Various pieces of information used in the deciding of the cooling setting temperature such as an update timing, a guaranteed operation period, an operation start date and time, a recommended intake air temperature, and a cooling setting temperature are stored in the memory 8. As the memory 8, for example a semiconductor memory such as a ROM or a RAM or a HDD may be used, similarly to as with the memory 6. The memory 8 may be provided in a plurality in accordance with the intended application and so forth. The processor 7 is capable of executing processing to decide upon the cooling setting temperature while reading out the above-described various pieces of information from the memory 6 or the memory 8. The method of deciding upon the cooling setting temperature will be described later.

In addition, the management blade 3 is connected to a terminal 9 so as to be capable of communicating therewith. The terminal 9 is used as a user interface. Signals including information input to the terminal 9 by the user are transmitted to the management blade 3 via an optical line or wirelessly for example. The terminal 9 is for example a personal computer (PC) or a mobile terminal such a mobile phone. It is also possible for a plurality of terminals 9 to be connected to a single management blade 3 so as to be capable of communicating therewith. It is also possible for a single terminal 9 to be connected to a plurality of management blades 3 so as to be capable of communicating therewith.

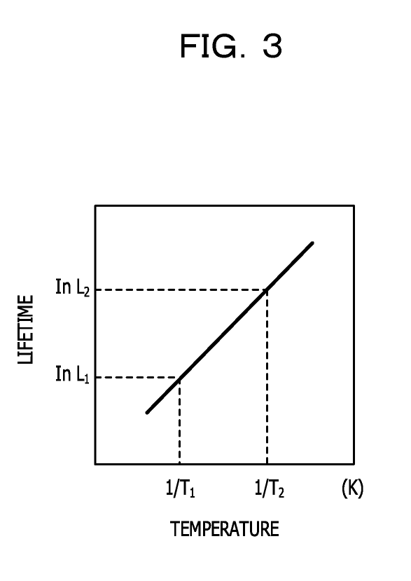

Next, operations related to cooling the information processing apparatus of the embodiment will be described while referring to FIGS. 3 to 8.

Degradation over time of an electronic device depends on the use environment temperature of the electronic device and the higher the use environment temperature is, the more readily degradation over time is accelerated. In the case where the main cause of degradation over time of an electronic device is the use environment temperature, a lifetime L of the electronic device may be approximated using the following Arrhenius model equation.

$$τ = A exp ( - \frac{Φ}{kT} ) \qquad ( 1 )$$

Here, A is a constant, Φ is activity energy, K is the Boltzmann constant, and T is the absolute temperature.

FIG. 3 illustrates an Arrhenius model based on Equation (1). The horizontal axis represents the reciprocal of the absolute temperature (in units of Kelvins) and the vertical axis represents the natural logarithm of the lifetime. L₁ is the lifetime in an environment of temperature T₁. L₂ is the lifetime in an environment of temperature T₂.

As illustrated in FIG. 3, the use environment temperature and the information processing apparatus follow the Arrhenius model and it is clear that the lower the use environment temperature is, the longer the lifetime is. Accordingly, it is preferable that the guaranteed operation period of the information processing apparatus be set by calculating the lifetime based on an assumed use environment temperature and adding a margin based on the calculated lifetime.

However, even when the guaranteed operation period is set assuming that the information processing apparatus will be used at the use environment temperature T₁, in an actual operation environment, the information processing apparatus may be used at the temperature T₂ that is lower than the assumed use environment temperature depending on the season for example. In such a case, since the remaining lifetime will be longer than assumed, a lifetime margin will be generated with respect to the originally assumed lifetime L₁. Thus, in the embodiment, the cooling setting temperature is decided upon and updated based on a lifetime margin generated during the guaranteed operation period, whereby it is possible to optimize the cooling conditions for the heat source.

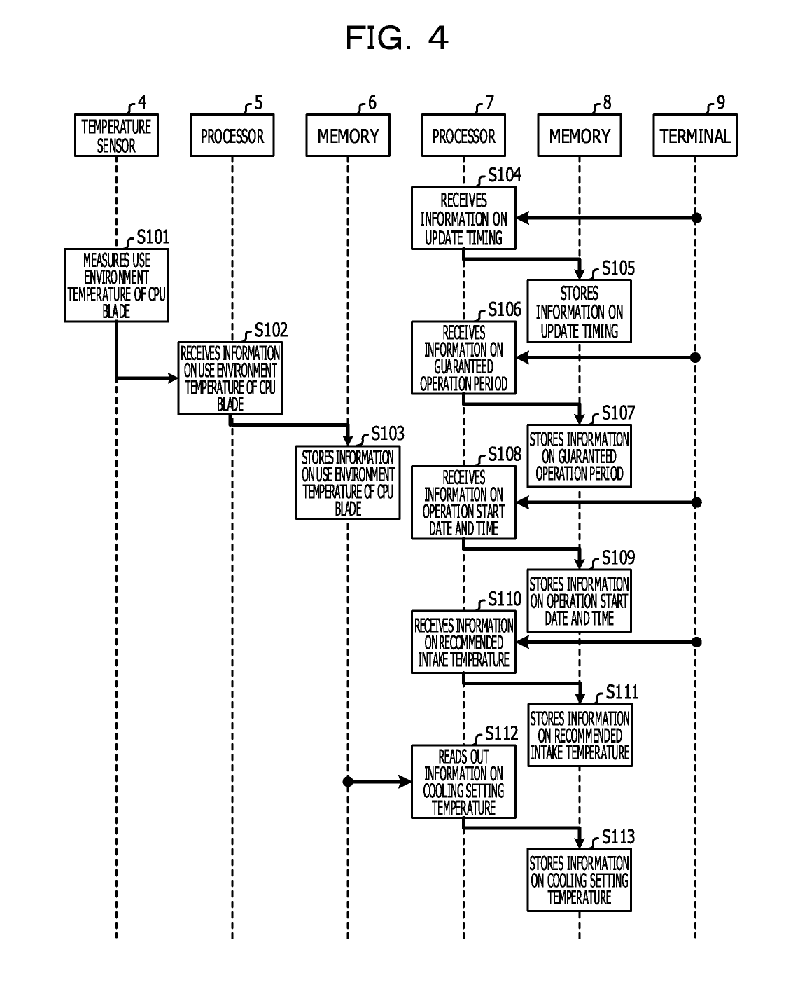

FIG. 4 is a sequence diagram illustrating processing of storing various pieces of information used in deciding upon the cooling setting temperature in the embodiment.

The processor 5 transmits a signal to the temperature sensor 4 instructing measurement of the use environment temperature of the CPU blade 1. Upon receiving the signal instructing measurement of the use environment temperature, the temperature sensor 4 measures the use environment temperature of the CPU blade 1 (S101). Then, the temperature sensor 4 transmits a signal including information on the measured use environment temperature to the processor 5. The processor 5 receives the signal including information on the use environment temperature from the temperature sensor 4 (S102). Then, the processor stores the information on the use environment temperature included in the signal in the memory 6 (S103). The use environment temperature of the CPU blade 1 is measured at intervals of 1 min for example.

The processor 7 receives a signal including information on an update timing from the terminal 9 (S104). Then, the processor 7 stores the information on the update timing included in the received signal in the memory 8 (S105). Here, the term “update timing” refers to information that indicates a timing at which the cooling setting temperature, which is an upper limit temperature that is not to be exceeded when cooling the CPU blade 1 (target temperature), is revised. The update timing may be information indicating a time interval at which deciding upon of the cooling setting temperature is to be performed or may be information indicating a date and time at which the cooling setting temperature is to be actually decided upon. The update timing may be set as a fixed time interval or may be set as a random time interval that is not fixed. For example, the update timing may be set so as to be shorter in the later half and longer in the first half of the guaranteed operation period by for example setting the update timing period to become increasingly shorter as the end of the guaranteed operation period approaches. With this method, even if sudden changes in the use environment temperature occur before expiration of the guaranteed operation period, it is possible to frequently correct the rotational speed of the cooling fan in accordance with these temperature changes. Consequently, it is possible to avoid a situation in which the lifetime ends before expiry of the guaranteed operation period.

The processor 7 receives a signal including information on the guaranteed operation period of the information processing apparatus from the terminal 9 (S106). Then, the processor 7 stores the information on the guaranteed operation period included in the received signal in the memory 8 (S107). Here, the term “guaranteed operation period” refers to a period of time for which the supplier of the information processing apparatus guarantees the user provided with the information processing apparatus that the information processing apparatus will operate without breaking down.

The processor 7 receives a signal including information on the operation start date and time of the CPU blade 1 from the terminal 9 (S108). Then, the information on the operation start date and time of the CPU blade 1 included in the received signal is stored in the memory 8 (S109). Here, the term “operation start date and time of the CPU blade 1” refers to a date and time when the CPU blade 1 started operating.

The processor 7 receives a signal including information on a recommended intake air temperature for the CPU blade 1 from the terminal 9 (S110). Here, the term “recommended intake air temperature for the CPU blade 1” is an intake air temperature specification recommended by the supplier of the CPU mounted in the CPU blade 1 and depends on the type of the CPU. As will be described later, the recommended intake air temperature of the CPU blade 1 may be used as an indicator that indicates a cooling upper limit temperature which may be permitted as a cooling setting temperature when cooling of the CPU blade 1 is being performed using the cooling device 2. The processor 7 stores information on the recommended intake air temperature of the CPU blade included in the received signal in the memory 8 (S111).

The processor 7 reads out a signal including information on the cooling setting temperature of the CPU blade 1 from the memory 6 (S112) and stores it in the memory 8 (S113).

The order of the processing operations performed in S101, S104, S106, S108, S110, and S112 is not limited and the processing operations may be performed in any suitable order.

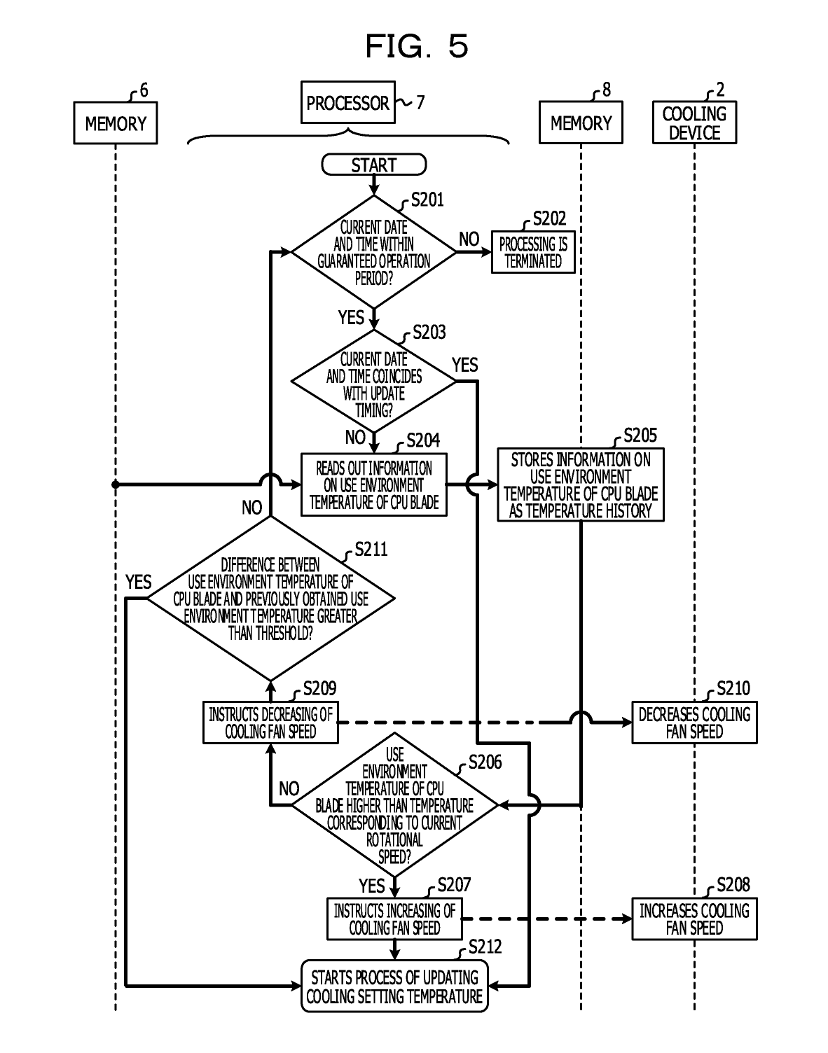

FIG. 5 is a sequence diagram illustrating processing from after storing of the various pieces of information used in deciding upon the cooling setting temperature up to the start of processing for deciding upon the cooling setting temperature in the embodiment.

The processor 7 reads out information on the guaranteed operation period and information on the operation start date and time of the CPU blade 1 stored in the memory 8. Then, the processor 7 determines whether the current date and time is within the guaranteed operation period based on these pieces of information (S201). If it is determined that the current date and time is not within the guaranteed operation period (No in S201), the processor 7 terminates the processing (S202). If it is determined that the current date and time is within the guaranteed operation period (Yes in S201), the processor 7 determines whether the current date and time coincides with an update timing of the cooling setting temperature (S203). If it is determined that the current date and time does not coincide with the update timing of the cooling setting temperature (No in S203), the processor 7 reads out information on the use environment temperature of the CPU blade 1 from the memory 6 (S204) and stores this information in the memory 8 (S205). Information on the use environment temperature stored in the memory 8 may be accumulated and used as temperature history information of the CPU blade 1. Then, the processing proceeds to S206. On the other hand, if it is determined that the current date and time does coincide with the update timing of the cooling setting temperature (Yes in S203), a process of updating the cooling setting temperature is started (S212). The process of deciding upon the cooling setting temperature will be described later.

In S206, the processor 7 reads out information on the latest use environment temperature of the CPU blade 1 from the memory 8. Then, the processor 7 determines whether the rotational speed of the cooling fan during operation is appropriate for the read out use environment temperature. If it is determined that the use environment temperature of the CPU blade 1 is higher than the use environment temperature that corresponds to the rotational speed of the cooling fan during operation (Yes in S206), the processor 7 transmits a signal to the cooling device instructing the cooling device to increase the rotational speed of the cooling fan (S207). Upon receiving the signal from the processor 7, the cooling device 2 increases the rotational speed of the cooling fan to the rotational speed that corresponds to the use environment temperature in accordance with the profile of the cooling fan rotational speed corresponding to the use environment temperature exemplified in FIG. 2 (S208). If it is determined that the use environment temperature of the CPU blade 1 is equal to or lower than the use environment temperature that corresponds to the rotational speed of the cooling fan during operation (No in S206), the processor 7 transmits a signal to the cooling device 2 instructing the cooling device 2 to decrease the rotational speed of the cooling fan (S209). Then, the processing proceeds to S211. Upon receiving the signal from the processor 7, the cooling device 2 decreases the rotational speed of the cooling fan to the rotational speed that corresponds to the use environment temperature in accordance with the profile of the cooling fan rotational speed corresponding to the use environment temperature exemplified in FIG. 2 (S210).

In S211, the processor 7 calculates the difference between the use environment temperature of the CPU blade 1 and the previously obtained use environment temperature of the CPU blade 1, and determines whether this difference is larger than a preset threshold. If it is determined that the difference between the currently obtained use environment temperature of the CPU blade 1 and the previously obtained use environment temperature of the CPU blade 1 is equal to or less than the threshold (No in S211), the processing proceeds to S201. If it is determined that the difference between the currently obtained use environment temperature of the CPU blade 1 and the previously obtained use environment temperature of the CPU blade 1 is larger than the threshold (Yes in S211), the processing proceeds to S212. Then, the processor 7 starts the process of updating the cooling setting temperature.

In this way, it is ensured that the cooling setting temperature is updated when a rapid change such as a temperature increase has occurred in the temperature history of the CPU blade 1 even if the update timing has not yet arrived. Since the remaining lifetime of the cooling target device will also change when a rapid change occurs in the temperature history, with this method, it is possible to change the cooling setting temperature in realtime in accordance with the changed remaining lifetime and it is possible to optimize the cooling setting temperature with higher precision.

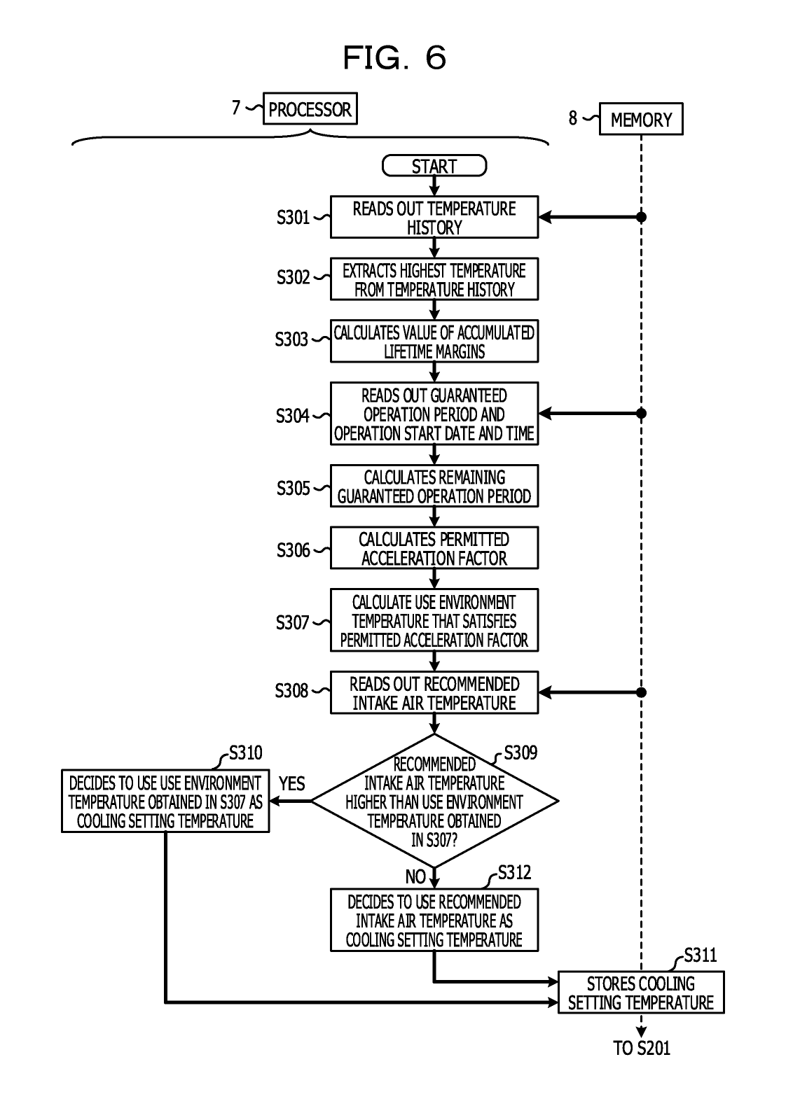

FIG. 6 is a sequence diagram illustrating processing of deciding upon the cooling setting temperature in the embodiment.

First, the processor 7 reads out the temperature history information regarding the use environment temperature of the CPU blade 1 from the memory 8 (S301).

Then, the processor 7 extracts the highest temperature from the readout temperature history information (S302).

Then, the value of accumulated lifetime margins in the period from the operation start date and time to the update timing is calculated (S303). Here, the term “lifetime margin” refers to a period of time gained as an extra amount of lifetime due to the information processing apparatus operating at use environment temperature lower than that assumed. In S303, the processor 7 calculates an acceleration factor for a time period between the previous update timing of the cooling setting temperature and the current update timing of the cooling setting temperature. Here, the term “acceleration factor” is defined as a ratio of the lifetime in a case where the information processing device operates at an actual use environment temperature T₂ to the lifetime in a case where the use environment temperature is fixed at a predetermined temperature T₁. The acceleration factor α may be expressed by the following equation by using the Arrhenius model equation.

$$( Acceleration Factor ) = \frac{{L}_{2}}{{L}_{1}} = \frac{A exp ( - \frac{Φ}{{kT}_{2}} )}{A exp ( - \frac{Φ}{{kT}_{1}} )} \qquad ( 2 )$$

After that, the lifetime margin is calculated using the acceleration factor. The lifetime margin may be obtained using the following Equation (3) for example.

(lifetime margin)=(time period between previous update timing of cooling setting temperature and current update timing of cooling setting temperature)×{1−(acceleration factor)} (3)

In the above equation, in the case where the current update timing of the cooling setting temperature is the first update timing after the start of operation of the information processing apparatus, the previous update timing of the cooling setting temperature is taken to be the operation start date and time.

Next, the processor 7 reads out the guaranteed operation period and the operation start date and time from the memory 8 (S304).

Then, the processor 7 calculates the remaining guaranteed operation period based on the read out guaranteed operation period and operation start date, and the current date and time (S305). The guaranteed operation period may be obtained using the following Equation (4).

(remaining guaranteed operation period)=(guaranteed operation period)−{(current date and time)−(operation start date and time)} (4)

Information on the current date and time is held by the management blade processing unit from the start, but may be obtained along with information on the guaranteed operation period and the operation start date and time from the memory 8.

Next, the processor 7 calculates a permitted acceleration factor by using the calculated remaining guaranteed operation period (S306). Here, the term “permitted acceleration factor” refers to the ratio of the remaining lifetime actually possessed at the time of the update timing with respect to the remaining guaranteed operation period at that time. The remaining lifetime and the permitted acceleration factor may be obtained from the following equations for example.

(remaining lifetime)=(remaining guaranteed operation period)+(value of accumulated lifetime margins) (5)

(permitted acceleration factor)=(remaining lifetime)/(remaining guaranteed operation period)=[(remaining guaranteed operation period)+(value of accumulated lifetime margins)]/(remaining guaranteed operation period) (6)

Here, the term “value of accumulated lifetime margins” refers to a sum of lifetime margins calculated from the operation start date and time up to the current update timing of the cooling setting temperature. In the case where there are lifetime margins calculated up to the present moment, a lifetime margin calculated at the current update timing of the cooling setting temperature is added to the value of these accumulated lifetime margins and the new value of accumulated lifetime margins is substituted into Equation (5). In the case where there are no lifetime margins calculated up to the present moment, the lifetime margin calculated this time is treated as the value of accumulated lifetime margins and substituted into Equation (5).

Next, the processor 7 calculates the use environment temperature that corresponds to the permitted acceleration factor by using the calculated permitted acceleration factor (S307). A use environment temperature T′₃ that corresponds to the permitted acceleration factor may be obtained by searching for a T′₃ that satisfies the below Equation (7) which uses the Arrhenius model equation in which L₃ is the remaining guaranteed operation period and L′₃ is the remaining lifetime. In this example, it is assumed that the use environment temperature is set in units of 1° C.

$$( Permitted Acceleration Factor ) > \frac{{L}_{3}^{′}}{{L}_{3}} = \frac{A exp ( - \frac{Φ}{{kT}_{3}^{′}} )}{A exp ( - \frac{Φ}{{kT}_{3}} )} \qquad ( 7 )$$

Next, the processor 7 reads out the recommended intake air temperature of the CPU blade 1 from the memory 8 (S308).

Next, the processor 7 compares the value of the read-out recommended intake air temperature of the CPU blade 1 with the use environment temperature T′₃ that corresponds to the permitted acceleration factor obtained in S308 (S309). In the case where it is determined that the value of the recommended intake air temperature of the CPU blade 1 is higher than T′₃ (Yes in S309), the processor 7 decides to use T′₃ as the cooling setting temperature (S310). Then, the processor 7 stores the decided upon value of the cooling setting temperature in the memory 8 as a new cooling setting temperature (S311). On the other hand, in the case where it is determined that the value of the recommended intake air temperature of the CPU blade 1 is equal to or less than T′₃ (No in S309), the processor 7 decides to use the recommended intake air temperature of the CPU blade 1 as the cooling setting temperature (S312).

Then, the processor 7 stores the decided upon value of the cooling setting temperature in the memory 8 as a new cooling setting temperature (S311). After S311, the processing returns once again to S201 illustrated in FIG. 5.

In this way, updating of the cooling setting temperature is performed.

Next, description will be given using an example of a case in which the disclosed technology is applied to the CPU blade 1 illustrated in FIG. 1.

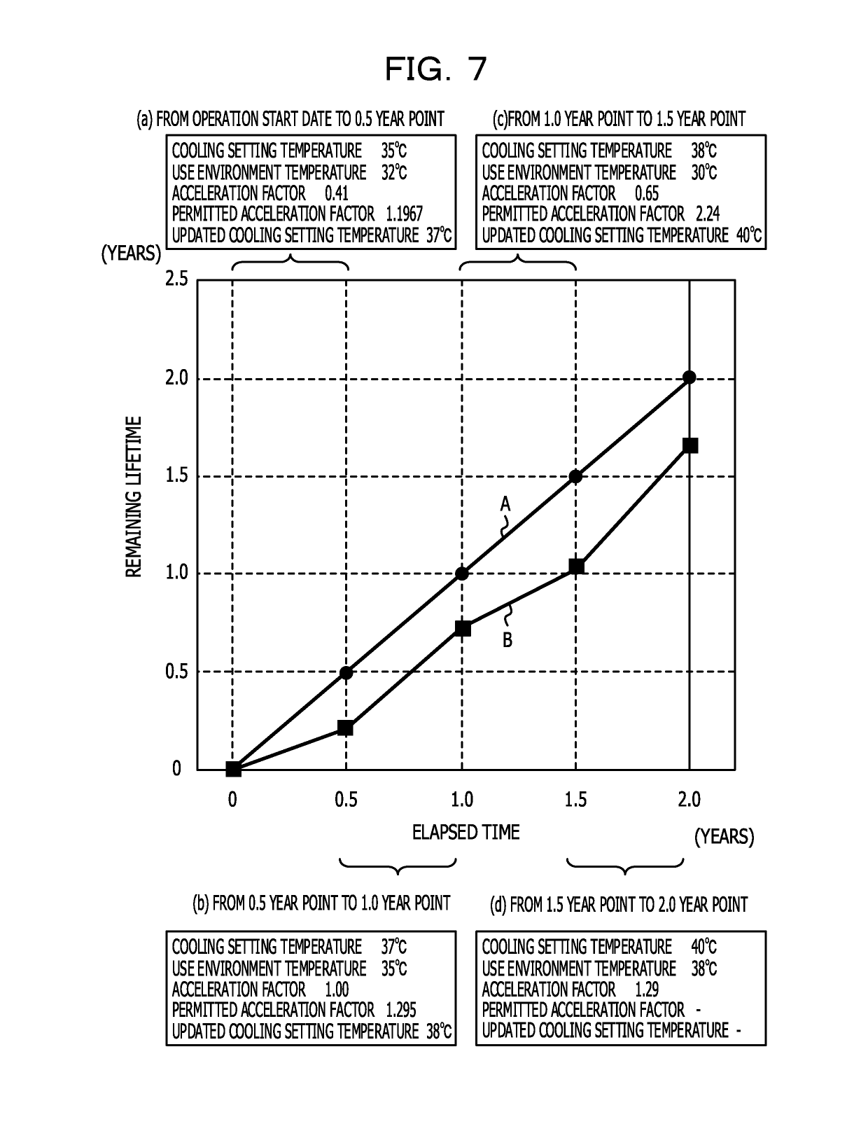

FIG. 7 is a diagram for explaining a relationship between time that has elapsed since the operation start date of the CPU blade 1 and consumed lifetime in the embodiment. The guaranteed operation period is taken to be two years, the horizontal axis represents time that has elapsed since the operation start date and the vertical axis represents the remaining lifetime. Graph A represents a case in which the cooling setting temperature is fixed at 35° C. and graph B represents a case in which the cooling setting temperature is updated every 0.5 years. The recommended intake air temperature of the CPU mounted in the CPU blade 1 is taken to be 45° C.

First, a method of updating the cooling setting temperature every 0.5 years from the operation start date will be described.

As an indicator of the consumed fraction of the lifetime, a ratio L_{0-0.5}/L₀ of a lifetime L_{0-0.5} in a case where the actual use environment temperature is T_{0-0.5} to an assumed lifetime L₀ in a case where the use environment temperature is presumed to be 35° C. (308.15 K) is defined as an acceleration factor α_{0-0.5}. Since the lifetime becomes shorter the higher the use environment temperature becomes, the highest temperature which is the worst case in this period is defined as the use environment temperature T_{0-0.5}. In a period from the operation start date until the 0.5 year point, in the case where the highest temperature T_{0-0.5} was 25° C. (298.15 K), if the activity energy is taken to be 0.7 eV, the acceleration factor α_{0-0.5} in this period is calculated from Equation (2) as

$${α}_{0 - 0.5} = \frac{{L}_{0 - 0.5}}{{L}_{0}} = \frac{A exp ( - \frac{Φ}{{kT}_{0 - 0.5}} )}{A exp ( - \frac{Φ}{{kT}_{0}} )} = \frac{exp ( - \frac{0.7}{8.617 \times {10}^{- 5} \times 298.15} )}{exp ( - \frac{0.7}{8.617 \times {10}^{- 5} \times 308.15} )} \approx 0.41 \qquad ( 8 )$$

That is, in the period from the operation start date until the 0.5 year point, a fraction 0.41 of the 0.5 years of lifetime is consumed. In other words, a gain of 1−0.41=0.59 of 0.5 years of lifetime is obtained.

In the period from the operation start date until the 0.5 year point, the remaining guaranteed operation period is 2-0.5=1.5 years from Equation (4). A period (lifetime margin) ΔT_{0-0.5} gained as an extra amount of lifetime over the assumed lifetime is 0.5×(1−0.41)=0.295 years from Equation (3). Therefore, the remaining lifetime 0.5 years after the operation start date, L′_{0-0.5} is calculated from Equation (5) as

$$\begin{matrix}{L}_{0 - 0.5}^{′} = ( remaining guaranteed operation period ) + Δ {T}_{0 - 0.5} \\ = 1.5 ( years ) + 0.295 ( years ) \\ = 1.795 ( years ) .\end{matrix} \qquad ( 9 )$$

If we define the ratio of the remaining lifetime L′_{0-0.5} to the remaining guaranteed operation period as a permitted acceleration factor β_{0-0.5}, β_{0-0.5} is calculated as

$$\begin{matrix}{β}_{0 - 0.5} = {L}_{0 - 0.5}^{′} \text{/} ( remaining guaranteed operation period ) \\ = 1.795 \text{/} 1.5 \\ = 1.1967\end{matrix} \qquad ( 10 )$$

Assuming that the cooling setting temperature is set in units of 1° C., the largest cooling setting temperature T_{0.5-1.0} that satisfies the permitted acceleration factor of 1.1967 may be obtained as T′_{0.5-1.0}=310.15 K (37° C.) from

$$\frac{A exp ( - \frac{Φ}{{kT}_{0 - 0.5}^{′}} )}{A exp ( - \frac{Φ}{{kT}_{0}} )} = \frac{exp ( - \frac{0.7}{8.167 \times {10}^{- 5} \times {T}_{0 - 0.5}^{′}} )}{exp ( - \frac{0.7}{8.167 \times {10}^{- 5} \times 308.15} )} < 1.1967 \qquad ( 11 )$$

Here, 37° C. is lower than the recommended intake air temperature of the CPU (45° C.) and therefore it is decided to use 37° C. as the cooling setting temperature for the period from the 0.5 year point to the 1 year point. The various pieces of numerical data obtained above are illustrated in (a) of FIG. 7.

The cooling device receives update data including the information of 37° C. as the decided upon cooling setting temperature from the management blade. The cooling device recognizes that the cooling setting temperature has been updated to 37° C. and changes the rotational speed of the cooling fan so that cooling may be performed at a cooling setting temperature of 37° C. The rotational speed corresponding to the cooling setting temperature of 37° C. is smaller than the rotational speed corresponding to the cooling setting temperature of 35° C. Therefore, it is possible to reduce power consumption while allowing the guaranteed operation period to be fulfilled.

Next, a method of updating the cooling setting temperature in the period from the 0.5 year point to the 1.0 year point will be described.

A ratio L_{0.5-1.0}/L₀ of the lifetime L_{0.5-1.0} in a case where the actual use environment temperature is T_{0.5-1.0} to an assumed lifetime L₀ in the case where the use environment temperature is assumed to be 35° C. is defined as an acceleration factor α_{0.5-1.0}. Here, the highest temperature which is a worst case in this period is defined as T_{0.5-1.0}.

In the period from the 0.5 year point to the 1.0 year point, in the case where the highest temperature T_{0.5-1.0} was 35° C. (298.15 K), the acceleration factor α_{0.5-1.0} in this period is calculated from Equation (2) as

$${α}_{0.5 - 1.0} = \frac{{L}_{0.5 - 1.0}}{{L}_{0}} = \frac{A exp ( - \frac{Φ}{{kT}_{0.5 - 1.0}} )}{A exp ( - \frac{Φ}{{kT}_{0}} )} = \frac{exp ( - \frac{0.7}{8.617 \times {10}^{- 5} \times 308.15} )}{exp ( - \frac{0.7}{8.617 \times {10}^{- 5} \times 308.15} )} = 1.00 \qquad ( 12 )$$

That is, in the period from the 0.5 year point to the 1.0 year point, it is clear that 1 times 0.5 years, that is, 0.5 years of lifetime is consumed as assumed.

In the period from the operation start date until the 1.0 year point, the remaining guaranteed operation period is 2.0−1.0=1.0 years from Equation (4). A lifetime margin ΔT_{0.5-1.0} in the period from the 0.5 year point to the 1.0 year point is 0.5×(1−1.00)=0 years from Equation (3). Therefore, the remaining lifetime 1.0 years after the operation start date, L′_{0.5-1.0} is calculated from Equation (5) as

$$\begin{matrix}{L}_{0.5 - 1.0}^{′} = ( remaining guaranteed operation period ) + \\ Δ {T}_{0 - 0.5} + Δ {T}_{0.5 - 1.0} \\ = 1.0 ( years ) + 0.295 ( years ) + 0 ( years ) \\ = 1.295 ( years )\end{matrix} \qquad ( 13 )$$

Defining the ratio of the remaining lifetime L′_{0.5-1.0} to the remaining guaranteed operation period as a permitted acceleration factor β_{0.5-1.0}, β_{0.5-1.0} is calculated as

$$\begin{matrix}{β}_{0.5 - 1.0} = {L}_{0.5 - 1.0}^{′} \text{/} ( remaining guaranteed operation period ) \\ = 1.295 \text{/} 1.0 \\ = 1.295\end{matrix} \qquad ( 14 )$$

Assuming the cooling setting temperature to be set in units of 1° C., the largest cooling setting temperature T′_{0.5-1.0} that satisfies the permitted acceleration factor of 1.295 may be obtained as T′_{0.5-1.0}=311.15 K (38° C.) from

$$\frac{A exp ( - \frac{Φ}{{kT}_{0.5 - 1.0}^{′}} )}{A exp ( - \frac{Φ}{{kT}_{0}} )} = \frac{exp ( - \frac{0.7}{8.167 \times {10}^{- 5} \times {T}_{0.5 - 1.0}^{′}} )}{exp ( - \frac{0.7}{8.167 \times {10}^{- 5} \times 308.15} )} < 1.295 \qquad ( 15 )$$

Here, 38° C. is lower than the recommended intake air temperature of the CPU (45° C.) and therefore it is decided that 38° C. is to be used as the cooling setting temperature for the period from the 1.0 year point to the 1.5 year point. The various pieces of numerical data obtained above are illustrated in (b) of FIG. 7.

The cooling device receives update data including the information of 38° C. as the decided upon cooling setting temperature from the management blade. The cooling device recognizes that the cooling setting temperature has been updated to 38° C. and changes the rotational speed of the cooling fan so that cooling may be performed at the cooling setting temperature of 38° C.

Next, a method of updating the cooling setting temperature in the period from the 1.0 year point to the 1.5 year point will be described.

A ratio L_{1.0-1.5}/L₀ of a lifetime L_{1.0-1.5} in a case where the actual use environment temperature is T_{1.0-1.5} in the period from the 1.0 year point to the 1.5 year point to an assumed lifetime Lₒ in a case where the use environment temperature is assumed to be 35° C. is defined as an acceleration factor α_{1.0-1.5}. Here, the highest temperature which is a worst case in this period is defined as T_{1.0-1.5}.

In the period from the 1.0 year point to the 1.5 year point, in the case where the highest temperature T_{1.0-1.5} was 30° C. (303.15 K), the acceleration factor α_{1.0-1.5} in this period is calculated from Equation (2) as

$${α}_{1.0 - 1.5} = \frac{{L}_{1.0 - 1.5}}{{L}_{0}} = \frac{A exp ( - \frac{Φ}{{kT}_{1.0 - 1.5}} )}{A exp ( - \frac{Φ}{{kT}_{0}} )} = \frac{exp ( - \frac{0.7}{8.617 \times {10}^{- 5} \times 303.15} )}{exp ( - \frac{0.7}{8.617 \times {10}^{- 5} \times 308.15} )} \approx 0.65 \qquad ( 16 )$$

That is, in the period from the 1.0 year point to the 1.5 year point, a period of a fraction 0.65 of 0.5 years of lifetime is consumed. In other words, a gain of 1−0.65=0.35 of 0.5 years of lifetime is obtained.

In the period from the operation start date until the 1.5 year point, the remaining guaranteed operation period is 2.0-1.5=0.5 years from Equation (4). In the period from the 1.0 year point to the 1.5 year point, a period (lifetime margin) ΔT_{1.0-1.5} gained as an extra amount of lifetime over the assumed lifetime is 0.5×(1−0.65)=0.325 years from Equation (3). Therefore, the remaining lifetime 1.5 years after the operation start date, L′_{1.0-1.5} is calculated from Equation (5) as

$$\begin{matrix}{L}_{1.0 - 1.5}^{′} = ( remaining guaranteed operation period ) + \\ Δ {T}_{0 - 0.5} + Δ {T}_{0.5 - 1.0} + Δ {T}_{1.0 - 1.5} \\ = 0.5 ( years ) + 0.295 ( years ) + 0 ( years ) + 0.325 ( years ) \\ = 1.12 ( years )\end{matrix} \qquad ( 17 )$$

Defining the ratio of the remaining lifetime L′_{1.0-1.5} to the remaining guaranteed operation period as a permitted acceleration factor β_{1.0-1.5}, β_{1.0-1.5} is calculated as

$$\begin{matrix}{β}_{1.0 - 1.5} = {L}_{1.0 - 1.5}^{′} \text{/} ( remaining guaranteed operation period ) \\ = 1.12 \text{/} 0.5 \\ = 2.24\end{matrix} \qquad ( 18 )$$

Assuming the cooling setting temperature to be set in units of 1° C., the highest cooling setting temperature T′_{1.0-1.5} that satisfies the permitted acceleration factor of 2.24 may be obtained as T′_{1.0-1.5}=313.15 K (40° C.) from

$$\frac{A exp ( - \frac{Φ}{{kT}_{1.0 - 1.5}^{′}} )}{A exp ( - \frac{Φ}{{kT}_{0}} )} = \frac{exp ( - \frac{0.7}{8.167 \times {10}^{- 5} \times {T}_{1.0 - 1.5}^{′}} )}{exp ( - \frac{0.7}{8.167 \times {10}^{- 5} \times 308.15} )} < 2.24 \qquad ( 19 )$$

Here, 40° C. is lower than the recommended intake air temperature (45° C.) of the CPU. Therefore, it is decided that 40° C. is to be used as the cooling setting temperature for the period from the 1.5 year point to the 2.0 year point. The various pieces of numerical data obtained above are illustrated in (c) of FIG. 7.

The cooling device receives update data including the information of 40° C. as the decided upon cooling setting temperature from the management blade. The cooling device recognizes that the cooling setting temperature has been updated to 40° C. and changes the rotational speed of the cooling fan so that cooling may be performed at a cooling setting temperature of 40° C.

The cooling device receives update data including the information of 40° C. as the decided upon cooling setting temperature from the management blade. The cooling device recognizes that the cooling setting temperature has been updated to 40° C. and changes the rotational speed of the cooling fan so that cooling may be performed at a cooling setting temperature of 40° C.

After that, as illustrated in FIG. 7, in the period from the 1.5 year point to the 2.0 year point, the highest temperature T_{1.5-2.0} of the use environment temperature was 38° C. (311.15 K). The acceleration factor in the period from the 1.5 year point to the 2.0 year point is 1.29. The remaining lifetime at the time of expiry of the guaranteed operation period is calculated as 1.26 years. The various pieces of numerical data obtained above are illustrated in (d) of FIG. 7.

Since the cooling setting temperature is exceeded in the case where the cooling setting temperature is fixed at 35° C., it is desirable that the rotational speed of the fan be increased to be higher than that when the use environment temperature is 35° C. and that cooling be performed until the use environment temperature is decreased to 35° C. In contrast, according to this embodiment, the cooling setting temperature is periodically revised based on the lifetime margins and in the example illustrated in FIG. 7 the cooling setting temperature is updated to 40° C., which is higher than 35° C. Therefore, the rotational speed of the cooling fan does not have to be increased.

Since the cooling setting temperature is exceeded in the case where the cooling setting temperature is fixed at 35° C., it is desirable that the rotational speed of the fan be increased to be higher than that when the use environment temperature is 35° C. and that cooling be performed until the use environment temperature is decreased to 35° C. In contrast, according to this embodiment, the cooling setting temperature is periodically revised based on the lifetime margins and in the example illustrated in FIG. 7 the cooling setting temperature is updated to 40° C., which is higher than 35° C. Therefore, the rotational speed of the cooling fan does not have to be increased.

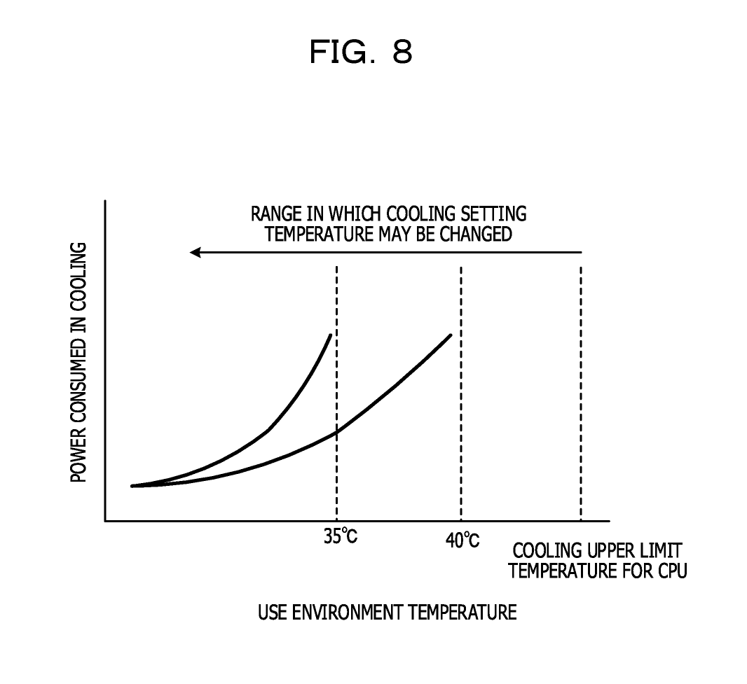

FIG. 8 is a diagram for explaining the effect of a reduction in power consumption by updating the cooling setting temperature. In FIG. 8, the horizontal axis represents the use environment temperature of the device that is a target of cooling and the vertical axis represents power consumed in cooling. Graph C represents a case in which the cooling setting temperature is 35° C. and Graph D represents a case in which the cooling setting temperature is updated from 35° C. to 40° C. As illustrated in FIG. 8, in the case where the use environment temperature has been changed from 35° C. to 40° C. for example, the power consumed in cooling at the use environment temperature of 35° C. is shifted to the position of an intersection point between a dotted line indicating the use environment temperature of 35° C. and the graph D. As a result, it is possible to perform setting such that the rotational speed of the cooling fan at the use environment temperature of 35° C. is smaller than that when the cooling setting temperature is 35° C. and therefore the power consumed in cooling is decreased. In this way, it is possible to reduce power consumption by performing processing to revise the cooling setting temperature during the guaranteed operation period.

Thus, in this example, the cooling setting temperature of the CPU blade is re-decided upon based on the remaining lifetime and the remaining guaranteed period, which are based on the temperature history of the CPU blade, and the temperature history. With this method, it is possible to optimize the cooling conditions for a source of heat while ensuring that the guaranteed operation period is fulfilled and therefore it is possible to save power used in cooling.

(Modifications)

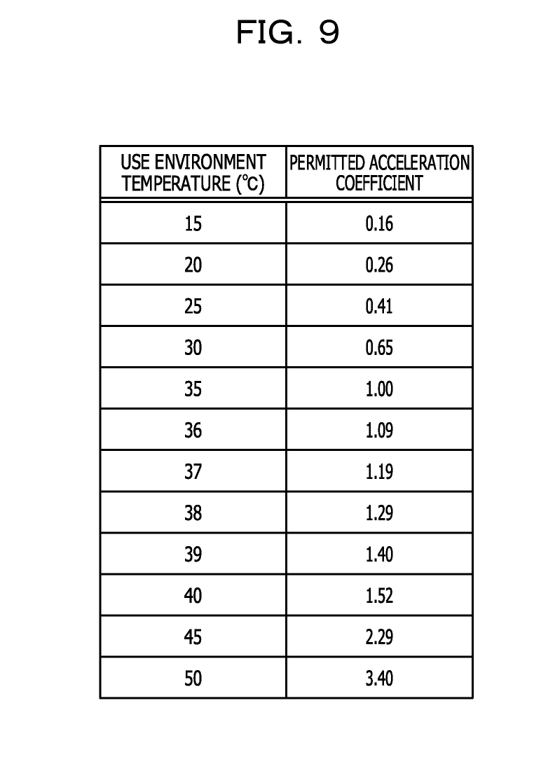

Next, a modification of the information processing apparatus of the embodiment will be described while referring to FIG. 9.

FIG. 9 illustrates an example of a database in which the use environment temperature and an acceleration factor are associated with each other. As illustrated in FIG. 9, data in which the acceleration factor and the use environment temperature are associated with each other is stored in the memory 8 of the information processing apparatus 10 illustrated in FIG. 1 as a database. The information processing apparatus 10 is able to find the largest use environment temperature that satisfies the permitted acceleration factor by searching the database. For example, in the case where the acceleration factor is calculated as 1.1967, referring to FIG. 7, it is clear that the value of the largest acceleration factor that satisfies 1.1967 is 1.19 and that the use environment temperature that corresponds to the acceleration factor of 1.19 is 37° C.

Thus, with the method in which the use environment temperature is obtained by using a database in which the acceleration factor and the use environment temperature are associated with each other, the use environment temperature may be obtained by sequentially comparing calculated acceleration factor with the acceleration factors stored in the memory 8. Therefore, compared with a method in which the use environment temperature is obtained by using an Arrhenius model equation as described above, it is possible to simplify the calculation process and improve the processing speed.

In addition, a system that performs the above-described cooling method, a computer program that causes a computer to perform the cooling method and a computer-readable recording medium on which the program is recorded are included in the scope of the embodiment. Here, a computer readable recording medium is for example a floppy disk, a hard disk, a compact disc-read only memory (CD-ROM), a magneto optical disk (MO), a digital video disc (DVD), a DVD-read only memory (DVD-ROM), a DVD-random access memory (DVD-RAM), a blue-ray disc (BD) or a semiconductor memory. In the embodiment illustrated in FIG. 1, for example, a computer program of the embodiment may be recorded in the memory 8. The computer program does not have to be recorded on a recording medium. The computer program may be transmitted via a telecommunications line or a wireless or wired communications line or via a network such as the Internet.

A preferred example has been detailed above, but the disclosure is not limited to this specific example and various modifications and changes are possible. For example, in a case where a plurality of CPUs are mounted in the CPU blade, a cooling device may be provided for each CPU and the cooling conditions may be individually controlled for each CPU. In this example, a CPU blade has been given as an example of an electronic device that is a target of cooling. However, the disclosed cooling method may also be for example applied to a cooling structure for a board on which semiconductor components that generate heat are mounted or for a single CPU mounted on a board inside an information processing apparatus such as a PC. In the example of processing illustrated in FIG. 5, the processing is terminated in S201 when the current date and time is not within the guaranteed operation period. However, even after the guaranteed operation period has expired, operation of the cooling fan may be allowed to continue as long as it is possible to maintain the recommended intake air temperature of the CPU.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A cooling method for cooling an electronic device that is performed by a processor included in an information processing apparatus, the cooling method comprising:
acquiring a temperature history of the electronic device during a guaranteed period of the electronic device;
determining a remaining lifetime of the electronic device by using a prediction model based on the temperature history;
determining a reference temperature corresponding to the remaining lifetime and a remainder of the guaranteed period, the remainder indicating a difference of the guaranteed period and a total operation time of the electric device; and
setting a target temperature to cool the electronic device based on a comparison between the reference temperature and a predetermined temperature indicating an upper limit of the target temperature.

2. The cooling method according to claim 1, wherein the setting includes:
setting the target temperature which is equal to the reference temperature when the reference temperature is lower than a predetermined temperature, and
setting the target temperature which is equal to the predetermined temperature when the reference temperature is equal to or greater than the predetermined temperature.

3. The cooling method according to claim 1,
wherein the setting includes setting the target temperature at a certain timing.

4. The cooling method according to claim 3,
wherein the setting of the target temperature includes setting a certain timing period that is shorter in a later half and longer in a former half of the guaranteed period.

5. The cooling method according to claim 3, further comprising:
calculating a temperature difference that represents a difference between an obtained temperature of the electronic device and a previously obtained temperature of the electronic device; and
determining whether the calculated temperature difference exceeds a preset threshold;
wherein the acquiring includes acquiring the temperature history regardless of the certain timing when it is determined that the calculated temperature difference exceeds the preset threshold.

6. The cooling method according to claim 1,
wherein the determining of the remaining lifetime includes:
calculating at every certain timing an acceleration factor that represents a ratio between a lifetime in a case where operation is performed at a preset use environment temperature and a lifetime that corresponds to an actual use environment temperature using the prediction model,
calculating, using the acceleration factor, an accumulated margin indicating an extended amount of lifetime obtained as a result of the electronic device being allowed to operate at a temperature lower than the preset use temperature in a period from a time point at which operation of the electronic device was started up to a timing at which the temperature history is obtained, and
calculating the remaining lifetime by adding the remaining guaranteed period to the calculated accumulated margin.

7. The cooling method according to claim 6,
wherein the determining of the use environment temperature includes:
calculating a permitted factor indicating a ratio of the remaining lifetime to the remaining guaranteed period, and
determining the use environment temperature based on the permitted factor.

8. The cooling method according to claim 6,
wherein the calculating of the accumulated margin includes:
calculating a lifetime margin in each of a plurality of periods separated by the certain timing in a period from the time point when operation of the electronic device was started until a timing at which the temperature history is obtained; and
calculating the accumulated margin by accumulating lifetime margins calculated in the plurality of periods.

9. The cooling method according to claim 1, further comprising:
controlling a cooling device such that a rotational speed of a cooling fan included in the cooling device which cools the electronic device becomes a rotational speed that corresponds to the determined reference temperature.

10. An information processing apparatus, comprising:
a memory, and
a processor coupled to the memory and configured to:
acquire a temperature history of the electronic device during a guaranteed period of the electronic device;
determine a remaining lifetime of the electronic device by using a prediction model based on the temperature history;
determine a reference temperature corresponding to the remaining lifetime and a remainder of the guaranteed period, the remainder indicating a difference of the guaranteed period and a total operation time of the electric device; and
set a target temperature to cool the electronic device based on a comparison between the reference temperature and a predetermined temperature indicating an upper limit of the target temperature.

11. The information processing apparatus according to claim 10, wherein the processor is configured to:
set the target temperature which is equal to the reference temperature when the reference temperature is lower than a predetermined temperature, and
set the target temperature which is equal to the predetermined temperature when the reference temperature is equal to or greater than the predetermined temperature.

12. The information processing apparatus according to claim 10,
wherein the processor is configured to set the target temperature at a certain timing.

13. The cooling method according to claim 10, wherein the processor is configured to:
calculate at every certain timing an acceleration factor that represents a ratio between a lifetime in a case where operation is performed at a preset use environment temperature and a lifetime that corresponds to an actual use environment temperature using the prediction model,
calculate, using the acceleration factor, an accumulated margin indicating an extended amount of lifetime obtained as a result of the electronic device being allowed to operate at a temperature lower than the preset use temperature in a period from a time point at which operation of the electronic device was started up to a timing at which the temperature history is obtained, and
calculate the remaining lifetime by adding the remaining guaranteed period to the calculated accumulated margin.

14. The cooling method according to claim 1,
wherein the processor is further configured to control a cooling device such that a rotational speed of a cooling fan included in the cooling device which cools the electronic device becomes a rotational speed that corresponds to the determined reference temperature.

15. A non-transitory computer-readable storage medium storing a program causing a computer to execute a process, the process comprising:
acquiring a temperature history of the electronic device during a guaranteed period of the electronic device;
determining a remaining lifetime of the electronic device by using a prediction model based on the temperature history;
determining a reference temperature corresponding to the remaining lifetime and a remainder of the guaranteed period, the remainder indicating a difference of the guaranteed period and a total operation time of the electric device; and
setting a target temperature to cool the electronic device based on a comparison between the reference temperature and a predetermined temperature indicating an upper limit of the target temperature.
